(19) United States
(12) Patent Application Publication
(10) Pub. No.: US 2024/0069229 A1
(43) Pub. Date: Feb. 29, 2024

(54) METHOD AND SYSTEM FOR PROCESSING SEISMIC IMAGES TO OBTAIN A FREQUENCY-DOMAIN REPRESENTATION OF A GEOLOGICAL FORMATION

(71) Applicant: TotalEnergies OneTech, Courbevoie (FR)

(72) Inventor: Noomane Keskes, Pau (FR)

(21) Appl. No.: 18/262,704

(22) PCT Filed: Jan. 25, 2021
(86) PCT No.: PCT/IB2021/000060

§ 371 Date: Jul. 24, 2023

(51) Int. Cl. G01V 1/30; G01V 1/34

(52) U.S. Cl. CPC G01V 1/301; G01V 1/345

(57) ABSTRACT

The present disclosure relates to a computer implemented method for processing a seismic image comprising seismic traces obtained from seismic measurements performed on a geological formation, said method comprising: determining an isochronous surface of the geological formation, based on the seismic image; determining an intersection point between each of a plurality of seismic traces and the isochronous surface; selecting an interval of pixels of each of the plurality of seismic traces, the interval of pixels being centered on the intersection point; converting to frequency-domain the values of each interval of pixels, thereby obtaining a plurality of frequency-domain representations of the isochronous surface associated to respective analysis frequencies; computing a histogram of the values of each of a plurality of frequency-domain representations of the isochronous surface; and selecting a reference frequency-domain representation of the isochronous surface based on the computed histograms.

### BACKGROUND

### Technical Field

The present disclosure relates to the processing of seismic images of a geological formation in order to derive information that may be used in the analysis of the geological formation by human interpreters.

### Description of the Related Art

It is known, especially in oil exploration, to determine the position of oil reservoirs from the results of geophysical measurements carried out from the surface or in well bores.

According to the technology of reflection seismology, these seismic measurements involve emitting a wave (e.g., acoustic waves) into the subsurface and measuring a signal comprising a plurality of echoes of the wave on geological structures being investigated. These structures are typically surfaces separating distinct materials, faults, etc. Other measurements may be carried out at wells bores.

Chrono-stratigraphic analysis (or sequence stratigraphic analysis) is very important to understand basin evolution, predict the sedimentary facies distribution for both hydrocarbon exploration and development. This analysis is based on the fundamental assumption that seismic reflectors are surfaces of chrono-stratigraphic significance. This assumption implies that an individual seismic reflector is a “time-line” through a depositional basin that represents a surface of the same geological age (i.e., an isochronous surface in geological time).

A seismic image (or seismic section) comprises a juxtaposition in a volume of sampled one-dimensional signals referred to as seismic traces. In the seismic image, the value of a pixel (a.k.a. voxel for 3D images) is proportional to the seismic amplitude represented by seismic traces.

Computing a chrono-stratigraphic representation of a seismic image often requires determining seismic horizon surfaces of the seismic image, wherein a seismic horizon surface corresponds to an estimated isochronous surface of the geological formation. Such seismic horizon surfaces can be used to determine a relative geological time (RGT) image of the geological formation, i.e., an image in which each pixel provides an estimated geological age for the portion of the geological formation represented by said pixel. The RGT image is referred to as “relative” because the purpose of the RGT image is mainly to be able to compare the estimated geological ages of different pixels, in order to, e.g., identify portions of the geological formation that have the same estimated geological age. Also, in practice, it is usually not possible to estimate an absolute geological age of any given portion of the geological formation. An RGT surface, i.e., a set of points of the RGT image which correspond to pixels having the same estimated geological age in said RGT image, represents also an estimated isochronous surface of the geological formation.

Lomask, et al., “Flattening without picking”, Geophysics Volume 71 Issue 4 (July-August 2006), pages P13-P20 (hereinafter “[LOMASK2006]”) describes a method for determining seismic horizon surfaces based on a seismic image, by computing the local seismic dip at each pixel of the seismic image and searching iteratively for surfaces having local gradients approaching the local seismic dips.

It also known, in order to analyze the geological formation, to perform a frequency-domain conversion of the seismic traces of the seismic image.

More generally speaking, many different types of processing data can be derived from a seismic image, which results in potentially overloading human interpreters since it remains challenging for a human interpreter to identify which processing data carries the most information on the geological information.

### BRIEF SUMMARY

The present disclosure aims at improving the situation. In particular, the present disclosure aims at overcoming at least some of the limitations of the prior art discussed above, by proposing a solution for automatically providing a human interpreter with a reduced amount of processing data with relevant information, thereby enabling and facilitating the analysis of the geological formation.

According to a first aspect, the present disclosure relates to a computer implemented method for processing a seismic image comprising seismic traces obtained from seismic measurements performed on a geological formation, said method comprising:
determining an isochronous surface of the geological formation;
determining an intersection point between each of a plurality of seismic traces and the isochronous surface;
selecting an interval of pixels of each of the plurality of seismic traces, said interval of pixels being centered on the intersection point;
converting to frequency-domain the values of each interval of pixels, thereby obtaining a plurality of frequency-domain representations of the isochronous surface associated to respective analysis frequencies;
computing a histogram of the values of each of a plurality of frequency-domain representations of the isochronous surface; and
selecting a reference frequency-domain representation of the isochronous surface based on the computed histograms.

Hence, the processing method determines an isochronous surface based on the seismic image. An isochronous surface corresponds to the positions in the seismic image of pixels which represent portions of the geological formation which are considered to have the same geological age.

Then an interval of pixels is selected for each of a plurality of seismic traces (preferably all seismic traces) of the seismic image, centered on the intersection point between the isochronous surface and the corresponding seismic trace, and the values of the intervals of pixels are converted into frequency-domain. Frequency-domain representations of the isochronous surface are therefore obtained for different analysis frequencies.

Hence, the above provisions enable to perform a frequency-domain analysis centered on the isochronous surface, rather than on an arbitrary horizontal surface. Accordingly, this enables to perform a kind of frequency-domain analysis with respect to geological time rather than the acquisition time of the seismic traces composing the seismic image. It should be noted that a horizontal surface in the seismic image (a.k.a. time slice surface) corresponds to a surface having the same acquisition time, while we consider instead an isochronous surface in the seismic image which is a surface having a same geological time, which in most cases will not be horizontal in the seismic image.

Also, in order to reduce the amount of information presented to a human interpreter, a reference frequency-domain representation is preferably selected among all the frequency-domain representations of the isochronous surface. For that purpose, a histogram is computed for each of a plurality of frequency-domain representations. Basically, a frequency-domain representation of the isochronous surface comprises a frequency-domain value for each seismic trace of the seismic image for a given analysis frequency, and a histogram of a frequency-domain representation of the isochronous surface represents the distribution of all the frequency-domain values of the considered frequency-domain representation. Such a histogram may be used to assess the relevance of the information provided by the corresponding frequency-domain representation. For instance, the range of frequency-domain values of the frequency-domain representation may be retrieved as the width of the histogram and used to identify the reference frequency-domain representation as the one having the greatest range of frequency-domain values.

Hence, the amount of processing data displayed to a human interpreter may be reduced by focusing on the reference frequency-domain representation of the isochronous surface, while ensuring that the displayed processing data represents relevant information by focusing on the isochronous surface (i.e., with respect to geological time) and using the histograms of the frequency-domain representations to select the reference frequency-domain representation.

In specific embodiments, the processing method can further comprise one or more of the following features, considered either alone or in any technically possible combination.

In specific embodiments, selecting the reference frequency-domain representation comprises computing a reference width for each histogram, the reference width of a histogram corresponding to the difference between a higher bound and a lower bound of the histogram, the reference frequency-domain representation corresponding to the frequency-domain representation having the greatest reference width.

In specific embodiments, the lower bound of a histogram is determined by discarding a first number of the lowest frequency-domain values of the frequency-domain representation associated to said histogram and/or the higher bound of a histogram is determined by discarding a second number of the highest frequency-domain values of the frequency-domain representation associated to said histogram. Indeed, a frequency-domain representation may comprise isolated highest and/or lowest frequency-domain values, which might increase the range of the frequency-domain values while most of the frequency-domain values (and the information thereof) may be concentrated in a reduced range. Such provisions are therefore advantageous in that isolated highest and/or lowest frequency-domain values, which artificially increase the range, are not considered for computing the reference width.

In specific embodiments, the first number and the second number correspond to respectively α₁×N_{occ} and α₂×N_{occ}, wherein N_{occ} corresponds to the total number of occurrences in the histogram, and 0.01%≤α₁, α₂≤1% or 0.05%≤α₁, α₂≤0.5%.

In specific embodiments, the processing method comprises generating a red-green-blue (RGB) image of the isochronous surface, said RGB image comprising red, green and blue channels, wherein the RGB image is generated based on the reference frequency-domain representation and on two other frequency-domain representations of the isochronous surface obtained for different analysis frequencies. Indeed, RGB images are convenient since they enable to display simultaneously three frequency-domain representations and since human vision is used to analyze such RGB images.

In specific embodiments:
the green channel of the RGB image corresponds to the reference frequency-domain representation of the isochronous surface; and
the red and blue channels correspond to frequency-domain representations associated to analysis frequencies located on either side of the analysis frequency of the reference frequency-domain representation.

This is advantageous in that human vision is particularly sensitive to green colors, naturally emphasizing the reference frequency-domain representation with respect to the two other frequency-domain representations.

In specific embodiments, the frequency-domain conversion uses a Fourier transform, preferably a Sparse Fourier Transform (SFT).

In specific embodiments, the processing method comprises applying a weighting window to the values of each interval of pixels, said weighting window comprising weighting coefficients having a maximum value at the middle of the weighting window, thereby obtaining weighted values for each interval of pixels, wherein the frequency-domain conversion is performed on the weighted values of the intervals of pixels.

In specific embodiments, the weighting coefficients combine a gaussian-like function with another windowing function, such as a Hamming function.

According to a second aspect, the present disclosure relates to a computer program product comprising instructions which, when executed by at least one processor, configure said at least one processor to carry out a processing method according to any one of the embodiments of the present disclosure.

According to a third aspect, the present disclosure relates to a non-transitory computer-readable storage medium comprising instructions which, when executed by at least one processor, configure said at least one processor to carry out a processing method according to any one of the embodiments of the present disclosure.

According to a fourth aspect, the present disclosure relates to a computer system for processing a seismic image, said computer system comprising at least one processor configured to carry out a processing method according to any one of the embodiments of the present disclosure.

### BRIEF DESCRIPTION OF THE SEVERAL VIEWS OF THE DRAWINGS

The disclosure will be better understood upon reading the following description, given as an example that is in no way limiting, and made in reference to the figures which show:

FIG. 1 provides an example of seismic image;

FIG. 2 is a flow chart illustrating the main steps of a method for processing a seismic image;

FIG. 3 provides examples of intervals of pixels on seismic traces of a seismic image, to be used for frequency-domain conversion;

FIG. 4 provides examples of histograms computed for different frequency-domain representations of a same isochronous surface;

FIG. 5 is a flow chart illustrating the main steps of a preferred embodiment of the processing method; and

FIG. 6 is a flow chart illustrating the main steps of a preferred embodiment of the processing method.

In these figures, identical references from one figure to another designate identical or analogous elements. For reasons of clarity, the elements shown are not to scale, unless explicitly stated otherwise.

### DETAILED DESCRIPTION

As discussed above, the present disclosure relates inter alia to a method 30 for processing seismic images.

A seismic image represents a picture of the subsoil arising from a seismic exploration survey. The seismic image comprises at least two dimensions which may comprise at least one horizontal dimension (which usually uses a distance scale, expressed, e.g., in meters) and one vertical dimension (which usually uses a distance scale or a time scale, expressed, e.g., in seconds). Hence, the seismic image may correspond to a 3D seismic image (with two horizontal dimensions and one vertical dimension) or to a 2D seismic image (with one horizontal dimension and one vertical dimension).

It is emphasized that the expressions “horizontal dimension” and “vertical dimension” are not to be interpreted as requiring these dimensions to be respectively strictly horizontal and strictly vertical. These expressions mean that one of the dimensions, referred to as “vertical dimension,” is representative of the depth of the geological formation, and that the other dimensions, referred to as “horizontal dimensions” are both orthogonal to the vertical dimension.

The seismic image is composed of pixels which may be 2D in case of a 2D seismic image or 3D (voxels) in case of a 3D seismic image. The pixels are regularly distributed according to a horizontal resolution on each horizontal dimension and a vertical resolution on the vertical dimension. The seismic image comprises, along each horizontal dimension:
a number of columns of pixels which is equal to the quotient of the horizontal extension along this horizontal dimension divided by the horizontal resolution along this horizontal dimension; each column of the seismic image may be referred to as “seismic trace”; and
a number of pixels per column which is equal to the quotient of the vertical extension divided by the vertical resolution.

Each pixel is associated with a seismic value which may be a gray value, for instance between 0 and 255 (or 65535). Each seismic value is representative of the amplitude of the seismic signal measured for the portion of the geological formation represented by the corresponding pixel.

In the sequel, a point corresponds to a set of coordinates in the grid of the seismic image, i.e., a set comprising a horizontal position along each horizontal dimension and a vertical position along the vertical dimension. A pixel therefore corresponds to a point with a value associated thereto (i.e., a seismic value in the case of a pixel of the seismic image, an estimated geological age in the case of a pixel of the RGT image, etc.).

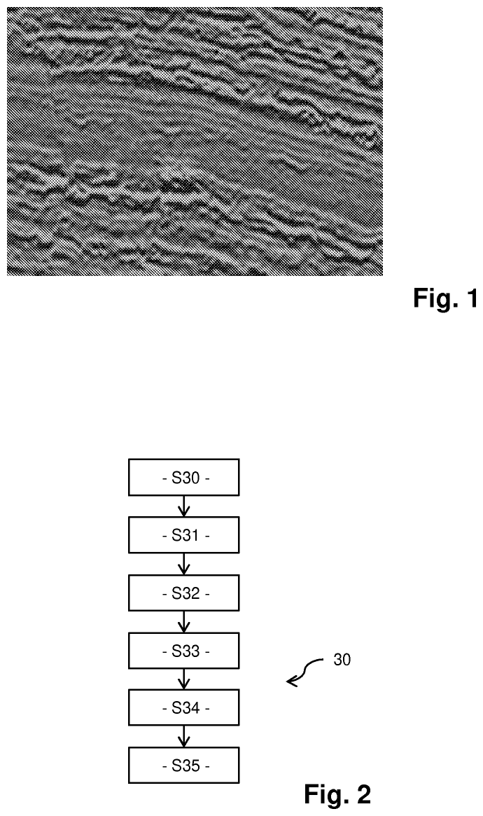

FIG. 1 represents an example of seismic image. The seismic image represented by FIG. 1 is 2D and may correspond to a 2D seismic image or to a 2D section of a 3D seismic image, in a vertical plane comprising one of its horizontal dimensions. As can be seen in FIG. 1, the seismic values highlight the composition of the geological formation, since high amplitude seismic values are usually associated to strong seismic reflectors, which are usually located at the interfaces between geological layers having different acoustic impedances.

The present disclosure applies for 2D seismic images and for 3D seismic images. In the sequel, we consider in a non-limitative manner the case of a 3D seismic image.

FIG. 2 represents schematically the main steps of an exemplary embodiment of a method 30 for processing a seismic image.

The processing method 30 is carried out by a computer system (not represented in the figures). In preferred embodiments, the computer system comprises one or more processors (which may belong to a same computer or to different computers) and storage means (magnetic hard disk, optical disk, electronic memory, or any computer readable storage medium) in which a computer program product is stored, in the form of a set of program-code instructions to be executed in order to implement all or part of the steps of the processing method 30. Alternatively, or in combination thereof, the computer system can comprise one or more programmable logic circuits (FPGA, PLD, etc.), and/or one or more application specific specialized integrated circuits (ASIC), etc., adapted for implementing all or part of said steps of the processing method 30. In other words, the computer system comprises a set of means configured by software (specific computer program product) and/or by hardware (processor, FPGA, PLD, ASIC, etc.) to implement the steps of the processing method 30.

As illustrated by FIG. 2, the processing method 30 comprises a step S30 of determining an isochronous surface of the geological formation.

As discussed above, an isochronous surface corresponds to the positions in the seismic image of pixels which represent portions of the geological formation which are considered to have the same geological age.

The isochronous surface may be obtained by any suitable means, including identified by a human interpreter and received in step S30 as an input to the processing method 30.

In preferred embodiments, the isochronous surface is determined by the computer system, based on the seismic image.

Seismic horizon surfaces, which may be determined by the computer system by using the method described in [LOMASK2006], in the patent applications EP 20306131.2 or FR 2869693, etc., are examples of isochronous surfaces that may be used in the processing method 30.

Also, such seismic horizon surfaces can be used to determine an RGT image of the geological formation. In an RGT image, each pixel provides an estimated geological age for the portion of the geological formation represented by said pixel. An RGT image may therefore be used to obtain RGT surfaces (see below) which are also examples of isochronous surfaces.

In general, RGT surfaces are more accurate than seismic horizon surfaces, since an RGT image is computed by using a large number of seismic horizon surfaces, thereby mitigating potential inaccuracies of some seismic horizon surfaces. Hence, using an RGT surface for the isochronous surface corresponds to a preferred embodiment of the present disclosure.

In the sequel, we consider in a non-limitative manner that the isochronous surface is an RGT surface retrieved from an RGT image of the geological formation, the RGT image being computed based on the seismic image. However, it is emphasized that the step S30 of determining an isochronous surface of the geological formation may use any method known to the skilled person for determining isochronous surfaces of a geological formation.

We assume that Mₕ seismic horizon surfaces τⁿ (1≤n≤Mₕ) have been determined by using any method known to the skilled person, for instance the method described in [LOMASK2006], in the patent applications EP 20306131.2 and FR 2869693, etc. The seismic horizon surfaces τⁿ are preferably distributed throughout the vertical dimension of the seismic image. Assuming that the seismic image comprises a horizontal dimension x with Nₓ pixels, a horizontal dimension y with N_{y} pixels and a vertical dimension t with Nₜ pixels, then the seismic horizon surface τⁿ of index n corresponds for instance to the set of points of the seismic image {(i, j, τⁿ(i, j)), 1≤i≤Nₓ, 1≤j≤N_{y}}.

Then the seismic horizon surfaces τⁿ may be used to compute an RGT image of the geological formation.

For example, the value of each pixel of the RGT image may correspond to the number of seismic horizon surfaces that comprise said considered pixel or that comprise any pixel located in the same column as the considered pixel, between the considered pixel and a reference pixel in the same column. The reference pixel on the vertical axis is the pixel of index k=Nₜ or, preferably, the pixel of index k=1.

For instance, it is possible to compute a stack image STK. The value of each pixel of the stack image STK corresponds to the number of seismic horizon surfaces that comprise said considered pixel. We can define a function Pos(i, j, k, n) which is such that:

$$Pos ( i , j , k , n ) = \{ \begin{matrix}1 if {τ}^{n} ( i , j ) = k \\ 0 if {τ}^{n} ( i , j ) \neq k\end{matrix}$$

Hence, the function Pos(i, j, k, n) indicates whether the seismic horizon surface T n passes by the pixel having the position (i, j, k). Based on the function Pos(i, j, k, n), the stack image STK may be computed as follows:

STK(i,j,k)=Σₙ₌₁^{M}^{ₕ}Pos(i,j,k,n)

for each 1≤i≤Nₓ, 1≤j≤N_{y}, 1≤k≤Nₜ, or limited to the pixels which are located inside a predetermined survey volume in the seismic image.

Then, assuming that the reference pixel is the pixel of index k=1, the RGT image may be computed as follows:

RGT(i,j,k)=Σₗ₌₁^{k}STK(i,j,l)

for each 1≤i≤Nₓ, 1≤j≤N_{y}, 1≤k≤Nₜ, or limited to the pixels which are located inside the survey volume. For the purpose of chrono-stratigraphic analysis, it is possible, in some embodiments, to normalize the RGT image by a predetermined reference geological age, such that the maximum value of the pixels of the RGT image is equal to the reference geological age.

Then the RGT image may be used to retrieve an RGT surface, i.e., a set of points of the RGT image which correspond to pixels having the same estimated geological age. If we denote by S^{iso} an RGT surface retrieved from the RGT image, then it corresponds to the following set of points of the RGT image:

{(i,j,S^{iso}(i,j)), 1≤i≤Nₓ, 1≤j≤N_{y}}

wherein RGT (i, j, S^{iso} (i, j))=K^{iso} for any (i, j) in the set {(i, j), 1≤i≤Nₓ, 1≤j≤N_{y}}, K^{iso} being the estimated geological age of the RGT surface S^{iso}, i.e., the isochronous surface determined during step S30.

As illustrated by FIG. 2, the processing method 30 comprises a step S31 of determining an intersection point between each of a plurality of seismic traces (preferably all) and the isochronous surface S^{iso}. Basically, for the seismic trace (column of the seismic image) having the horizontal positions (i, j), then the intersection point corresponds to the point (i, j, S^{iso} (i, j)).

As illustrated by FIG. 2, the processing method 30 comprises a step S32 of selecting an interval of pixels of each considered seismic trace, said interval of pixels being centered on the intersection point. It is assumed that all interval of pixels have the same number of pixels Nᵢₙₜ.

We denote by I_{S} the seismic image, which corresponds to the set of pixels {I_{S}(i, j, k), 1≤i≤Nₓ, 1≤j≤N_{y}, 1≤k≤Nₜ}. Hence, if we assume that each interval of pixels comprises Nᵢₙₜ=(2×N_{int/2}) pixels, the interval of pixels for the seismic trace having the horizontal positions (i, j), denoted by IT_{i,j}, may correspond to the set of pixels:

IT_{i,j}={I_{S}(i,j,S^{iso}(i,j)−N_{int/2}+k), 1≤k≤Nᵢₙₜ}

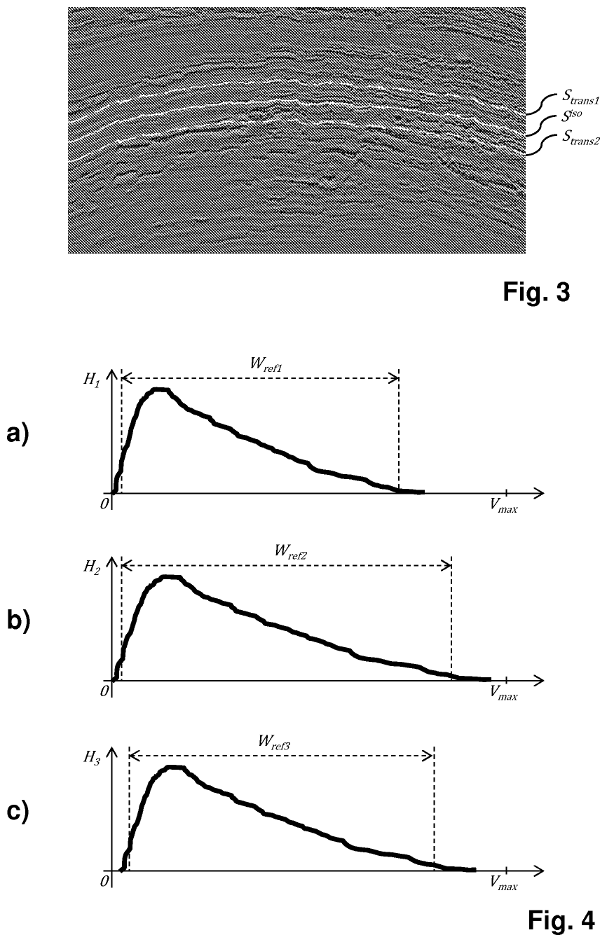

FIG. 3 represents schematically a 2D section of a 3D seismic image, in a vertical plane comprising one of its horizontal dimensions. FIG. 3 represents also the isochronous surface S^{iso} determined, together with the intervals of pixels centered on said isochronous surface S^{iso}. Basically, the intervals of pixels lie between two boundary surfaces Sₜᵣₐₙₛ₁ and Sₜᵣₐₙₛ₂ obtained by translating the isochronous surface S^{iso} by respectively (−N_{int/2}+1) and N_{int/2} pixels along the vertical dimension.

As illustrated by FIG. 2, the processing method 30 comprises a step S33 of converting to frequency-domain the values of each interval of pixels.

This frequency-domain conversion may use any method known to the skilled person, for instance a Fourier transform and preferably a Sparse Fourier Transform (SFT). Hence, a frequency-domain representation is obtained for each interval of pixels, over a plurality of analysis frequencies. For a given analysis frequency, the set of frequency-domain values obtained for all the intervals of pixels corresponds to a frequency-domain representation of the isochronous surface S^{iso}. Hence, the frequency-domain conversion step S33 provides a plurality of frequency-domain representations of the isochronous surface S^{iso} associated to respective analysis frequencies.

Basically, for the interval of pixels having the horizontal positions (i,j), the frequency-domain conversion provides a set of frequency-domain values associated to respective analysis frequencies:

Fc(IT_{i,j})={FV_{i,j}(fₚ), 1≤p≤N_{freq}}

wherein:
FC is the frequency-domain conversion function, for instance a Fourier transform such as an SFT;
N_{freq} is the number of analysis frequencies;
fₚ is the analysis frequency of index p (1≤p≤N_{freq}); for instance, the analysis frequencies are separated by a predetermined frequency gap δf, i.e., (fₚ₊₁−fₚ)=δf ∀1≤p≤N_{freq}−1; for instance, with Nᵢₙₜ=64 and a seismic sampling rate of 4 milliseconds (vertical resolution), we get δf≈3.9 hertz; and
FV_{i,j}(fₚ) is the frequency-domain value obtained for the interval of pixels having the horizontal positions (i,j), for the analysis frequency fₚ of index p (1≤p≤N_{freq}).

The frequency-domain representation FR^{iso} (fₚ) of the isochronous surface S^{iso} for the analysis frequency fₚ corresponds to the following set of frequency-domain values:

FR^{iso}(fₚ)={FV_{i,j}(fₚ), 1≤i≤Nₓ, 1≤j≤N_{y}}

Such frequency-domain representations FRᵢₛₒ are therefore obtained for a plurality of analysis frequencies during step S33.

As illustrated by FIG. 2, the processing method 30 comprises a step S34 of computing a histogram of the values of each of a plurality of frequency-domain representations of the isochronous surface S^{iso}.

Basically, a histogram Hₚ of a frequency-domain representation FRᵢₛₒ(fₚ) of the isochronous surface S^{iso} represents the distribution of all the frequency-domain values {FV_{i,j}(fₚ), 1≤i≤Nₓ, 1≤j≤N_{y}}. For instance, if each histogram Hₚ is assumed to comprise Nₕᵢₛₜ values defined over a predetermined interval [0, Vₘₐₓ], then the histogram value Hₚ(h), 1≤h≤Nₕᵢₛₜ, corresponds for instance to the number of frequency-domain values FV_{i,j}(fₚ) of the frequency-domain representation FR^{iso}(fₚ), hereinafter referred to as number of occurrences, that are such that:

(h−1)×Vₘₐₓ/Nₕᵢₛₜ≤|FV_{i,j}(fₚ)|<h×Vₘₐₓ/Nₕᵢₛₜ

wherein |x| denotes the norm of x.

Of course, the histogram may also be computed differently, for instance as representing the cumulative distribution of all the frequency-domain values {FV_{i,j}(fₚ), 1≤i≤Nₓ, 1≤j≤N_{y}}. Such a histogram, for instance denoted H′ₚ, is for instance computed as:

$${H}_{p}^{′} ( h ) = {\sum }_{l = 1}^{h} {H}_{p} ( l ) \qquad ( l )$$

Also, the histograms Hₚ or H′ₚ may be normalized, for instance such that Σₕ₌₁^{N}^{ₕᵢₛₜ} Hₚ(h)=1 (i.e., H′ₚ (Nₕᵢₛₜ)=1). In the sequel, we consider in a non-limitative manner the case of a histogram as defined by Hₚ.

As illustrated by FIG. 2, the processing method 30 comprises also a step S35 of selecting a reference frequency-domain representation of the isochronous surface S^{iso} based on the computed histograms.

Basically, the histograms computed may be analyzed to identify a frequency-domain representation of the isochronous surface S^{iso}, referred to as reference frequency-domain representation, that is considered to carry the most useful information on the geological formation. The reference frequency-domain representation may then be displayed, at least initially, to a human interpreter for analyzing the geological formation.

Different criteria may be used to select the reference frequency-domain representation of the isochronous surface S^{iso} based on the computed histograms, and the choice of a specific criterion corresponds to a specific embodiment of the present disclosure.

For instance, it is possible to compute the mean and/or variance of each histogram, and to select as the reference frequency-domain representation the one associated to the histogram exhibiting the greatest mean and/or variance.

According to another example, it is possible to compute the actual width of each histogram, and to select as the reference frequency-domain representation the one associated to the histogram exhibiting the greatest actual width. For instance, the actual width of a histogram Hₚ is computed as follows:

hₘₐₓ×Vₘₐₓ/Nₕᵢₛₜ−(hₘᵢₙ−1)×Vₘₐₓ/Nₕᵢₛₜ

wherein:
hₘᵢₙ is the lowest index for which Hₚ (hₘᵢₙ)≠0 (i.e., Hₚ (h)=0 for any h<hₘᵢₙ, if hₘᵢₙ≠1); and
hₘₐₓ is the highest index for which Hₚ (hₘₐₓ)≠0 (i.e., Hₚ (h)=0 for any h>hₘₐₓ, if hₘₐₓ≠Nₕᵢₛₜ).

More generally, it is possible to compute a reference width of each histogram, and to select as the reference frequency-domain representation the one associated to the histogram exhibiting the greatest reference width. The reference width of a histogram corresponds to the difference between a higher bound and a lower bound of the histogram.

For instance, the higher bound may be hₘₐₓ×Vₘₐₓ/Nₕᵢₛₜ and the lower bound may be (hₘᵢₙ−1)×Vₘₐₓ/Nₕᵢₛₜ, in which case the reference width corresponds to the actual width discussed above.

In preferred embodiments, the reference width is computed by discarding some of the lowest and/or some of the highest frequency-domain values of the histogram, which may be isolated in some cases, thereby artificially increasing the actual width of the histogram.

For instance, it is possible to discard the value Hₚ (hₘᵢₙ) and/or the value Hₚ (hₘₐₓ). In such a case, the reference width may be computed as follows:

(hₘₐₓ−1)×Vₘₐₓ/Nₕᵢₛₜ(hₘᵢₙ)×Vₘₐₓ/Nₕᵢₛₜ

More generally, it is possible, in some examples, to discard a predetermined number L of histogram values, in which case the reference width may be computed as follows:

(hₘₐₓ−L)×Vₘₐₓ/Nₕᵢₛₜ−(hₘᵢₙ−1+L)×Vₘₐₓ/Nₕᵢₛₜ

In preferred embodiments, the lower bound corresponds to the highest value below which a number of occurrences in the histogram is lower than a predetermined first threshold and/or the higher bound corresponds to the lowest value above which a number of occurrences in the histogram is lower than a predetermined second threshold. For instance, the first threshold and the second threshold may be defined as respectively α₁×N_{occ} and α₂×N_{occ}, wherein N_{occ} corresponds to the total number of occurrences in the histogram, i.e., the total number of frequency-domain values FV_{i,j}(fₚ) considered for computing the histogram Hₚ. Hence, N_{occ}=Nₓ×N_{y} if the frequency-domain conversion is performed on all seismic traces.

Assuming that both the first threshold and the second threshold are used, and that the histogram Hₚ is not normalized (i.e., Σₕ₌₁^{N}^{ₕᵢₛₜ}Hₚ(h)=N_{occ}), then the reference width of a histogram Hₚ may be computed as follows:

hₐ_{₂}×Vₘₐₓ/Nₕᵢₛₜ−(hₐ_{₁}−1)×Vₘₐₓ/Nₕᵢₛₜ

wherein:
hₐ_{₁} is the highest index for which

$${\sum }_{h = 1}^{{h}_{{α}_{1}} - 1} {H}_{p} ( h ) \leq {α}_{1} \times {N}_{occ} , i . e . , {Σ}_{h = 1}^{{h}_{{α}_{1}}} {H}_{p} ( h ) > {α}_{1} \times {N}_{o c c} ;$$

and
hₐ_{₂} is the lowest index for which

$${\sum }_{{h}_{{α}_{2}} + 1}^{{N}_{hist}} {H}_{p} ( h ) \leq {α}_{2} \times {N}_{occ} , i . e . , {Σ}_{{h}_{{α}_{2}}}^{{N}_{hist}} {H}_{p} ( h ) > {α}_{2} \times {N}_{o c c} .$$

Basically, this corresponds to computing the reference width of the histogram Hₚ by discarding the α₁×N_{occ} lowest frequency-domain values FV_{i,j}(fₚ) of the frequency-domain representation FR^{iso}(fₚ) and by discarding the α₂×N_{occ} highest frequency-domain values FV_{i,j}(fₚ) of the frequency-domain representation FR^{iso}(fₚ).

Preferably, 0.01%≤α₁, α₂≤1% or 0.05%≤α₁, α₂≤0.5%. In some embodiments, α₁ and α₂ may be equal, for instance α₁=α₂=0.1%.

FIG. 4 represents schematically three different histograms. More specifically, part a) of FIG. 4 represents a histogram H₁ computed for a frequency-domain representation FR^{iso}(f₁). Part b) of FIG. 4 represents a histogram H₂ computed for a frequency-domain representation FR^{iso}(f₂). Part c) of FIG. 4 represents a histogram H₃ computed for a frequency-domain representation FR^{iso}(f₃). FIG. 4 represents also the lower and higher bounds obtained by considering α₁=α₂=0.1%, and the corresponding reference widths referred to as W_{ref1}, W_{ref2} and W_{ref3}. As can be seen in FIG. 4, the histogram H₂ is the one exhibiting the greatest reference width such that, in this example, the frequency-domain representation FR^{iso}(f₂) may be selected as the reference frequency-domain representation of the isochronous surface S^{iso}.

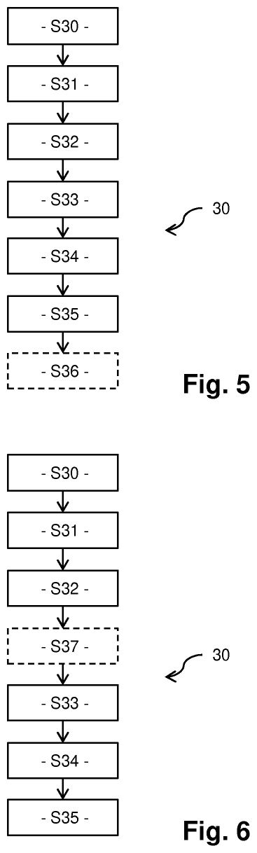

FIG. 5 represents schematically the main steps of a preferred embodiment of the processing method 30. As illustrated by FIG. 5, the processing method 30 comprises, in addition to the steps described in reference to FIG. 2, a step S36 of generating a red-green-blue (RGB) image of the isochronous surface S^{iso} based on at least the reference frequency-domain representation of said isochronous surface S^{iso}.

For instance, the RGB image, which comprises red, green and blue channels, may be generated based on the reference frequency-domain representation and based on two frequency-domain representations of the isochronous surface S^{iso} selected among the other frequency-domain representations of the isochronous surface S^{iso}. For instance, each channel of the RGB image may correspond to one of these three frequency-domain representations of the isochronous surface S^{iso}. Preferably, the green channel of the RGB image corresponds to the reference frequency-domain representation of the isochronous surface and the red and blue channels correspond to frequency-domain representations associated to analysis frequencies located on either side of the analysis frequency of the reference frequency-domain representation. Hence, if we denote by f_{ref} the analysis frequency of the reference frequency-domain representation FR^{iso}(f_{ref}) of the isochronous surface S^{iso}, and by fₐᵤₓ₁ and fₐᵤₓ₂ the analysis frequencies of the two other selected frequency-domain/representations FR^{iso}(fₐᵤₓ₁) and FR^{iso}(fₐᵤₓ₂), with fₐᵤₓ₁<f_{ref}<fₐᵤₓ₂, then:
the red channel may display the frequency-domain representation FR^{iso}(fₐᵤₓ₁);
the green channel may display the reference frequency-domain representation FR^{iso}(f_{ref}); and
the blue channel may display the frequency-domain representation FR^{iso}(fₐᵤₓ₂).

For instance, the frequency-domain representations FR^{iso}(fₐᵤₓ₁) and FR^{iso}(fₐᵤₓ₂) may be selected based on the histograms computed. According to another example, the analysis frequencies fₐᵤₓ₁ and fₐᵤₓ₂ may be selected based on the analysis frequency f_{ref}. For instance, these analysis frequencies may be selected such that (f_{ref}−fₐᵤₓ₁)=(fₐᵤₓ₂−f_{ref})=Δf, wherein Δf is a predetermined frequency distance. For instance, Δf=K×δf of wherein K is a predetermined integer factor. K is for instance lower or equal than 5.

FIG. 6 represents schematically the main steps of a preferred embodiment of the processing method 30. As illustrated by FIG. 6, the processing method 30 comprises, in addition to the steps described in reference to FIG. 2 and prior to performing the frequency-domain conversion, a step S37 of applying a weighting window to the values of each interval of pixels, thereby obtaining weighted values for each interval of pixels. The frequency-domain conversion is performed on the weighted values of the intervals of pixels.

Basically, the weighting window comprises weighting coefficients having a maximum value at the middle of the weighting window, in order to focus the frequency-domain analysis around the isochronous surface S^{iso}.

In preferred embodiments, the weighting coefficients are computed based on a Gaussian-like function centered on the middle of the weighting window. A Gaussian-like function is for instance given by the following expression:

GF(k)=A×exp(−|k−N_{int/2}|^{α})

wherein A is a predetermined strictly positive factor, α is a predetermined strictly positive factor and 1≤k≤Nᵢₙₜ. For instance, 0.5≤α≤3.

Preferably, the weighting coefficients are computed by combining a Gaussian-like function with another windowing function (rectangular, triangular, Han, Hamming, etc.). In a preferred example, the other windowing function is a Hamming function, in which case the weighting coefficients WC(k), 1≤k≤Nᵢₙₜ, are for instance given by:

WC(k)=B×GF(k)×Hamming(k)

wherein B is a predetermined strictly positive factor and Hamming(k), 1≤k≤Nᵢₙₜ, is for instance given by:

Hamming(k)=0.54−0.46×cos(2×π×k/Nᵢₙₜ)

Applying the weighting window to the values of each interval of pixels provides weighted intervals of pixels WIT_{i,j} on which the frequency domain conversion may be performed:

WIT_{i,j}={WC(k)×I_{S}(i,j,S^{iso}(i,j)−N_{int/2}+k), 1≤k≤Nᵢₙₜ}

It is emphasized that the present disclosure is not limited to the above exemplary embodiments. Variants of the above exemplary embodiments are also within the scope of the present invention.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method implemented by a computer for processing a seismic image comprising seismic traces obtained from seismic measurements performed on a geological formation, said method comprising:
determining an isochronous surface of the geological formation;
determining an intersection point between each of a plurality of seismic traces and the isochronous surface;
selecting an interval of pixels of each of the plurality of seismic traces, said interval of pixels being centered on the intersection point;
converting to frequency-domain the values of each interval of pixels, thereby obtaining a plurality of frequency-domain representations of the isochronous surface associated with respective analysis frequencies;
computing a histogram of the values of each of a plurality of frequency-domain representations of the isochronous surface; and
selecting a reference frequency-domain representation of the isochronous surface based on the computed histograms.

2. The method according to claim 1, wherein selecting the reference frequency-domain representation comprises computing a reference width for each histogram, the reference width of a histogram corresponding to a difference between a higher bound and a lower bound of the histogram, the reference frequency-domain representation corresponding to the frequency-domain representation having the greatest reference width.

3. The method according to claim 2, wherein the lower bound of the histogram is determined by discarding a first number of the lowest frequency-domain values of the frequency-domain representation associated with said histogram and/or the higher bound of the histogram is determined by discarding a second number of the highest frequency-domain values of the frequency-domain representation associated with said histogram.

4. The method according to claim 3, wherein the first number and the second number correspond to, respectively, α₁×N_{occ} and α₂×N_{occ}, wherein N_{occ} corresponds to a total number of occurrences in the histogram, and 0.01%≤α₁, α₂≤1% or 0.05%≤α₁, α₂≤0.5%.

5. The method according to claim 1, comprising generating a red-green-blue (RGB) image of the isochronous surface, said RGB image comprising red, green and blue channels, wherein the RGB image is generated based on the reference frequency-domain representation and on two other frequency-domain representations of the isochronous surface obtained for different analysis frequencies.

6. The method according to claim 5, wherein:
the green channel corresponds to the reference frequency-domain representation of the isochronous surface; and
the red and blue channels correspond to frequency-domain representations associated to analysis frequencies located on either side of the analysis frequency of the reference frequency-domain representation.

7. The method according to claim 1, wherein the frequency-domain conversion uses a Sparse Fourier Transform (SFT).

8. The method according to claim 1, comprising applying a weighting window to the values of each interval of pixels, said weighting window comprising weighting coefficients having a maximum value at the middle of the weighting window, thereby obtaining weighted values for each interval of pixels, wherein the frequency-domain conversion is performed on the weighted values of the intervals of pixels.

9. The method according to claim 8, wherein the weighting coefficients combine a gaussian-like function with another windowing function.

10. (canceled)

11. A non-transitory computer-readable storage medium comprising instructions which, when executed by at least one processor, configure said at least one processor to carry out a processing method according to claim 1.

12. A computer system for processing a seismic image, said computer system comprising at least one processor configured to carry out a processing method according to claim 1.
